(19) United States
(12) Patent Application Publication
(10) Pub. No.: US 2005/0068162 A1
(43) Pub. Date: Mar. 31, 2005

(54) Tamperproof occupant detection and alarm system for vehicles

(76) Inventors: Cathy D. Santa Cruz, Reno, NV (US); Richard M. Early, Reno, NV (US); Thomas G. Eaton, Woodland, CA (US)

Correspondence Address: Cathy D. Santa Cruz, 7630 Tholl Drive, Reno, NV, 89506, US

(21) Appl. No.: 10/673,614

(22) Filed: Sep. 29, 2003

(51) Int. Cl. B60Q 1/00

(52) U.S. Cl. 340/457; 340/667

(57) ABSTRACT

A tamperproof occupant detection and alarm system for vehicles which when installed within any vehicle seat, and/or within a child's safety seat functions as a notification means to notify either the driver or passerby's that an occupant (such as a child or pet) still remains in the vehicle, including novel and unique safety features.

### FIELD OF THE INVENTION

This invention relates generally to alarm systems such as those typically associated with vehicles, but more particularly pertains to a system wherein if a child or a pet has been accidentally left in the vehicle the alarm will sound and notify passerby's that there is an emergency situation and the occupant is in need of help. Furthermore, the system is tamper-proof and when the ignition switch assumes the off position, a timer is activated which senses the condition of a weight sensor, and if a pre-determined weight remains within the vehicle seat(s) the alarm system is automatically activated.

### BACKGROUND OF THE INVENTION

Vehicle operators sometimes park their vehicles and inadvertently leave their pets inside the automobile, particularly in the back seat. Similarly, some automobile owners have been known to inadvertently lock their children in a parked automobile. If the pet or child is trapped in the automobile for an extended period of time, or during extreme temperatures, the pet or child typically suffers adverse health effects. This is most unfortunate as there have actually been many instances wherein a child or pet has been trapped in a parked automobile and as a result they have died.

Within the known prior art, there have been numerous attempts to address and resolve this problem, such as taught within U.S. Pat. Nos. 5,260,684, 5,793,291 and 6,489,889. Wherein sensors and/or electronics of different types have been used, including temperature sensors, motion sensors, and the like. However, such attempts have not been successful and/or effective as they are much to complicated and expensive to install. Other examples include standard alarm systems that protect an automobile from vandalism and burglary by sounding an alarm when a locked automobile door is opened without a key, or upon physical contact with the exterior of a locked automobile. Such alarms, while substantially preventing an automobile from vandalism and burglary, do not detect the presence of a person or animal confined within a locked automobile.

To increase the safety of a child within a car, safety devices such as car seats have been developed. However, each of the known safety devices are designed to increase a child's safety while the automobile is moving, i.e., during automobile operation. Such devices do not prevent a child or pet from inadvertently being locked in a parked automobile.

Thus it would be most advantageous to provide an alarm system within a vehicle that automatically notifies either the owner or passerby's that there is an unattended pet or child in the vehicle and assistance is required. Also, it is important that such a system be tamper-proof, easy to install, inexpensive and most of all very functional.

### SUMMARY OF THE INVENTION

It is therefore a primary object of the present invention to provide a detection system coupled to the existing burglar alarm system within a vehicle and which senses if there is an occupant seated therein. The detection system is in electrical communication with a timer that is triggered by the ignition switch when the switch assumes the off position, and if the detection system determines there is a predetermined weight upon the seat(s), the alarm is automatically activated.

It is another object of the present invention to provide the detection means with safety features so as if tampered with, the alarm is again automatically activated, and/or the vehicle will not be operable.

Still another object of the present invention is to provide an occupant detection means wherein any suitable type of weight sensor of engineering choice may be incorporated and easily installed within the vehicle seat(s) and/or child safety seat, and/or a combination thereof. This may be accomplished either at the point of manufacture or by after market installation by a qualified technician.

Yet another object of the present invention is to provide a programmable detection means whereby a predetermined weight is set and cannot be tampered with, such as six pounds or more.

A further object of the present invention is to provide an occupant detection system that includes a backup battery means. Whereby if the vehicle battery is disconnected, the detection system and burglar alarm system are both still operable. Also, if the backup battery is not functioning, or if it is low on voltage, signal means are provided so as to inform the driver of the condition. Thereafter, if the battery fails or is not recharged the driver will be informed that the vehicle will be inoperable once the ignition switch assumes the off position.

Yet another object of the present invention is to provide a vehicle occupant detection system whereby if at any time the weight is lifted off of the seat and then replaced while the vehicle's ignition switch is in the off or locked position, the timer is automatically reactivated and after a predetermined interval, such as two minutes, the burglar alarm system will resume activation until the weight has been removed again.

Still another object of the present invention is to provide a vehicle occupant detection system which is tamperproof This is very important, as if the owner of the vehicle or any other person tries to disable the system, the vehicle will not be operable. This is accomplished by safety wiring installed at numerous locations of engineering choice. For example, tamperproof wiring is used and interconnected to either one or all of the electrical components within the vehicle. The electrical components include but are not limited to; the ignition switch, the timer, door lock switch or relay, vehicle lights, horn relay or switch, fuel pump relay, transmission switch or relay, electronic control module, a backup battery, etc. Whereby, if any of these wires or the electronics are tampered with the vehicle will not operate.

A further object of the present invention is to provide an occupant detection system wherein an occupant sensor is installed either within the vehicle seat(s), within a child seat, and/or within the safety belts and it may be of any suitable type of engineering choice. For example, the occupant sensor may be a mechanical switch, an optical detector, a heat detector, a sonar detector and/or any type of weight detector, etc.

Yet another object of the present invention is to provide an occupant detection and alarm system that may either be installed at the site of manufacture which is preferred, or the system can be a retrofit, respectively.

Another very important object is to provide a different use for the occupant detection and alarm system that is very novel. For example, the system could be installed within a mattress, a child's crib or the like. Whereby, when the child has been put to bed, the system is turned on and if someone removes the child, or rather the weight from the mattress is removed, the alarm automatically activates. Thus this is an excellent deterrent for kidnapping, etc.

Other objects and advantages will be seen when taken into consideration with the following specification.

### BRIEF DESCRIPTION OF THE DRAWINGS

FIG. 1 is a schematic illustration of the occupant detection and alarm system in accordance with one embodiment of the present invention when installed within a vehicles electrical system, respectively.

### DETAILED DESCRIPTION OF THE DRAWINGS

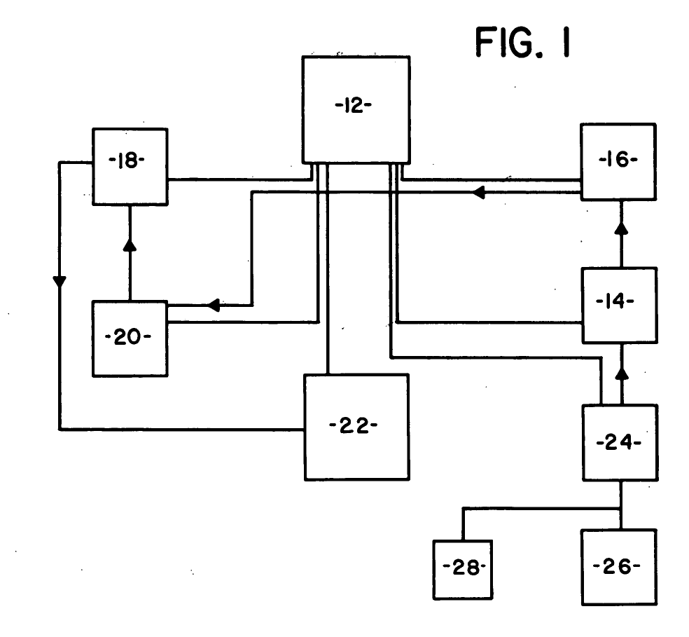

Referring now in detail to the drawing wherein like characters refer to like elements depicted therein. As illustrated in FIG. 1, (10) is an overview for a tamperproof occupant detection and alarm system for a vehicle and includes typical electrical components that are addressed hereafter.

The present system (10) includes at least the following electrical components but not limited thereto: a first power source (12) such as a typical vehicle battery or the like, a typical ignition switch (14), an ignition detection means (16), a weight detection means (18) a timer (20) and a vehicle alarm system (22) all of which are electrically interconnected and energized by the first power source (12), respectively.

It is to be understood the weight detection means (18) is to be located and installed within either a vehicle seat located within the vehicle or within a child's safety seat positioned and secured upon the vehicle seat. It is to be further understood any suitable type of weight detection means of engineering choice may be used.

Whereby, in use when ignition switch (14) assumes an “off” or locked position, the ignition detection means (16) signals the timer (20), which in turn automatically activates for a predetermined time. Thereafter, when the predetermined time has elapsed, weight detection means (18) is then activated, and if the weight detection means detects a predetermined weight remains thereon, the alarm system automatically activates until the predetermined weight has been removed.

It is to be noted the components above are completely functional in themselves but it is contended that further safety features should be included, depending on engineering choice. For example, we further depict a second power source (24) having notification means. Whereby, if first power source (12) fails, second power source (24) is automatically activated and serves to energize the weight detection means (18) and the associated electronics. Thus, if the weight detection means (18) detects a predetermined weight remains thereon, the alarm system (22) automatically activates until the predetermined weight has been removed. Thus the second power source deters anyone from trying to disconnect the system, as it will still function.

Yet another safety feature includes if a low power condition or failure of the previously noted second power source (24) is detected, the notification means notifies the driver of the condition or failure. Whereby, when the notification means is activated while the vehicle is running, the vehicle will not be operable once the ignition switch (14) resumes the off position, until the second power source (24) is again functioning.

Still another safety feature is provided wherein the notification means is further electrically connected to at least one or a combination of the vehicles other operational components. For example, the notification means may be connected to (including but not limited to) either the ignition means, a fuel pump mechanism, transmission mechanism, electronic control module and/or the first power source, etc., depending on engineering choice. Whereby, if someone were to tamper with the one, or a combination of the noted components, the vehicle will be disabled, respectively.

Still another safety feature is to include if a low power condition or failure of the second power source (24) is detected, the notification means notifies the driver of the condition or failure. Whereby, if the notification means is activated while the vehicle is not running, the vehicle will not be operable until the second power source is again functioning. This may be accomplished by the notification means being electrically connected to at least one or a combination of the previously noted vehicles operation components.

It is to be noted many variants and embodiments are possible, thus the embodiment as depicted herein is only exemplary. It is to be further noted the weight detection means is programmable so as to provide the predetermined weight when programmed. For example, the predetermined weight may be 6 pounds, or the like, depending on engineering choice. This is also true for the timer as it is programmable and can be programmed for at least 30 seconds or the like, again depending on engineering choice.

Yet another important feature may be to include a safety sensor means (28) for sensing the overall condition of the system, whereby if the system is not operating, the alarm system automatically activates.

Still another feature is to include that when the system is activated due to the weight detection means being triggered, if the weight is temporarily removed and then replaced before the ignition switch assumes the “on” position, the timer is again activated.

It will now be seen we have herein provided a new and improved means for providing a tamperproof occupant detection and alarm system which has heretofore not been taught.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

1. A tamperproof occupant detection and alarm system for a vehicle comprising: electrical components including a first power source; an ignition switch; an ignition detection means; a weight detection means; a timer; and a vehicle alarm system; said weight detection means being located within either a vehicle seat located wiin a vehicle or within a child's safety seat positioned and secured upon said vehicle seat, and said electronic components being electrically interconnected and energized by said first power source,
whereby:
when said ignition switch assumes an “off” or locked position, said timer automatically activates for a predetermined time, after said predetermined time has elapsed, said weight detection means is then activated, and if said weight detection means detects a predetermined weight remains thereon, said alarm system automatically activates until said predetermined weight has been removed.

2. The detection and alarm system of claim 1 further includes a second power source having notification means;
whereby:
if said first power source fails, said second power source is automatically activated and serves to energize said weight detection means and associated electronics,
whereby:
if said weight detection means detects a predetermined weight remains thereon, said alarm system automatically activates until said predetermined weight has been removed.

3. The detection and alarm system of claim 2 wherein if a low power condition or failure of said second power source is detected, said notification means notifies the driver of said condition or failure,
whereby:
if said notification means is activated while said vehicle is running, said vehicle will not be operable once said ignition switch resumes said off position until said second power source is again functioning.

4. The detection and alarm system of claim 3 wherein said notification means is further electrically connected to at least one or a combination of the vehicles operational components, said vehicles operational components including but not limited to said ignition means, fuel pump mechanism, transmission mechanism, electronic control module and/or said first power source.

5. The detection and alarm system of claim 2 wherein if a low power condition or failure of said second power source is detected, said notification means notifies the driver of said condition or failure,
whereby:
if said notification means is activated while said vehicle is not running, said vehicle will not be operable until said second power source is again functioning.

6. The detection and alarm system of claim 5 wherein said notification means is electrically connected to at least one or a combination of the vehicles operational components, said vehicles operational components including but not limited to said ignition means, fuel pump mechanism, transmission mechanism, electronic control module, and/or said first power source.

7. The detection and alarm system of claim 1 wherein said weight detection means is programmable, and said predetermined weight is 6 pounds.

8. The detection and alarm system of claim 1 wherein said timer is programmable, and said predetermined time is at least 30 seconds.

9. The detection and alarm system of claim 1 further includes sensor means for sensing the condition of said system,
whereby:
if said system is not operating, said alarm system automatically activates.

10. A tamperproof occupant detection and alarm system for a vehicle comprising: electrical components including a first power source; an ignition switch; an ignition detection means; a weight detection means; a timer; and a vehicle alarm system; said weight detection means being located within either a vehicle seat located within a vehicle or within a child's safety seat positioned and secured upon said vehicle seat, and said electronic components being electrically interconnected and energized by said first power source,
whereby:
when said ignition switch assumes an “off” or locked position, said timer automatically activates for a predetermined time, after said predetermined time has elapsed, said weight detection means is then activated, and if said weight detection means detects a predetermined weight remains thereon, said alarm system automatically activates until said predetermined weight has been removed,
whereby:
if said weight is removed and then replaced before said ignition switch assumes said on position, said timer is again activated.
